(19) United States
(12) Patent Application Publication
(10) Pub. No.: US 2006/0143605 A1
(43) Pub. Date: Jun. 29, 2006

(54) Method and system for installing multi-language program

(75) Inventor: Bruce Cao, Shindian City (TW)

Correspondence Address: BIRCH STEWART KOLASCH & BIRCH, PO BOX 747, FALLS CHURCH, VA, 22040-0747, US

(73) Assignee: VIA Technologies, Inc.

(21) Appl. No.: 11/153,617

(22) Filed: Jun. 16, 2005

(30) Foreign Application Priority Data
Dec. 24, 2004 (TW) 093140691

(51) Int. Cl. G06F 9/445

(52) U.S. Cl. 717/174

(57) ABSTRACT

A method and system for installing multi-language program. An original installing program having a default string is provided, and at least one foreign string corresponding to the default string is generated. The default string and the foreign string are correspondingly recorded in a string table. A user interface is provided to display the foreign string retrieved from the string table.

### BACKGROUND OF THE INVENTION

1. Field of Invention

The invention relates to a method and system for program installation and, in particular, to a method and system for installing multi-language program.

2. Related Art

Recently the developments of electronic and information industries have the trend of facilitating user operations. Electronic hardware has the trend of plug-and-play, and the installation of software has become more convenient. For example, for the software developed using the Installshield Developer, a user can finish the installation simply by following the instructions of the Installshield during installation.

Generally speaking, English is the most common default language for software development. That is, the texts during installation and operation are in English. However, software showing only English texts is not convenient for users whose mother tongue is non-English, for they may not understand the meaning of the texts. This may results in installation errors and abandonment of the users.

In view of this problem, software developers often develop installing programs in other languages. For instance, Chinese users can download Chinese-Traditional installing programs. The operation instructions are displayed in Chinese in the Chinese-Traditional installing programs. This facilitates the operations of Chinese users.

However, the costs of those installing programs in other languages may be higher than the installing programs in the default language. Furthermore, some of the languages in the installing programs may be still missing due to the unfamiliar of software developers, which results in the inconvenient of the users. Moreover, the size of the installing programs in multiple languages may be larger than the installing program in default language, and results in transmission difficulties.

Therefore, to provide a method and system for installing multi-language program that can solve the above-mentioned problems has become an important issue.

### SUMMARY OF THE INVENTION

In view of the foregoing, the invention is to provide a method and system for installing multi-language program that has a low cost, a smaller size, and is easy to modify.

To achieve the above, a method for installing multi-language program of the invention includes the following steps of: providing an original installing program having a default string; generating at least one foreign string corresponding to the default string; recording the default string and the foreign string correspondingly in a string table; and providing a user interface to display the foreign string retrieved from the string table.

In addition, the invention also discloses a system for installing multi-language program, which includes a string table and a user interface. The string table is recorded with a default string of an original installing program and a corresponding foreign string generated according to the default string. The user interface displays the foreign string retrieved from the string table.

Since the method and system for installing multi-language program according to the invention utilize the string table of a plug-in to record strings in different languages, the developing costs can be reduced when compared to conventional installing multi-language programs. Furthermore, the string table has a smaller size, thus is easier for transmission. Moreover, since one can modify strings in the string table, it is much convenient for one who wants to change the texts displayed.

### BRIEF DESCRIPTION OF THE DRAWINGS

The invention will become more fully understood from the detailed description given herein below illustration only, and thus is not limitative of the present invention, and wherein:

FIG. 1 is a flowchart showing the steps of the method for installing multi-language program according to the preferred embodiment of the invention;

FIG. 2 is a flowchart showing the steps of the method for installing multi-language program according to another embodiment of the invention;

FIG. 3 is a schematic diagram showing the string table according to an embodiment of the invention;

FIG. 4 is a schematic diagram showing the system for installing multi-language program according to the preferred embodiment of the invention; and

FIG. 5 is a schematic diagram showing the screenshots of the system for installing multi-language program according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

In the method and system for installing multi-language program according to the embodiments, a plug-in is added without modifying the contents of the original installing program. Using this plug-in, users from different countries may select their preferred language as the language displayed on the user interface to install any program more easily.

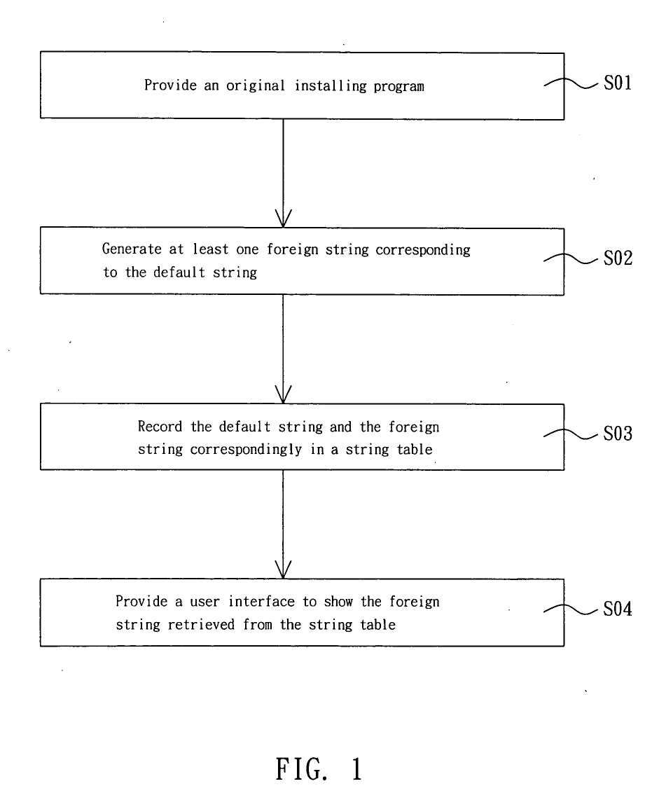

Please refer to FIG. 1, which illustrates the steps of the method for installing multi-language program according to the preferred embodiments of the invention. The method is implemented in cooperation with an original installing program. First, the original installing program is provided (S01). This original installing program has a default string. Then, at least one foreign string corresponding to the default string is generated (S02). Afterwards, the default string and the foreign string are recorded correspondingly in a string table (S03). A user interface is then provided (S04) for showing the foreign string retrieved from the string table.

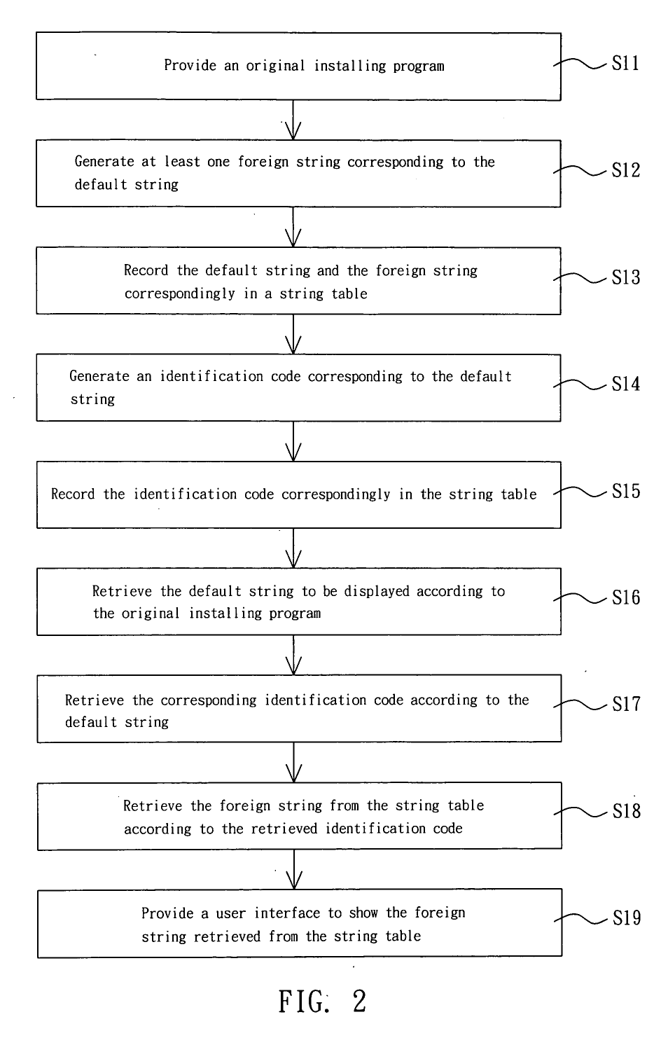

As shown in FIG. 2, the method for installing multi-language program according to the preferred embodiments of the invention may be divided further into the following steps. Firstly, the original installing program is provided (S11). This original installing program has a default string. Then, at least one foreign string corresponding to the default string is generated (S12). Afterwards, the default string and the foreign string are recorded correspondingly in a string table (S13). An identification code corresponding to the default string is then generated (S14) and recorded in the string table (S15). The default string to be displayed is retrieved according to the original installing program (S16), and then the corresponding identification code is retrieved according to the default string (S17). The foreign string is retrieved from the string table according to the retrieved identification code (S18). A user interface is then provided (S19), which shows the foreign string retrieved from the string table. Comparing the steps shown in FIG. 1 and FIG. 2, steps S11 to S13 are similar to steps S01 to S03, and steps S16 to S19 are the detailed illustrations of step S04.

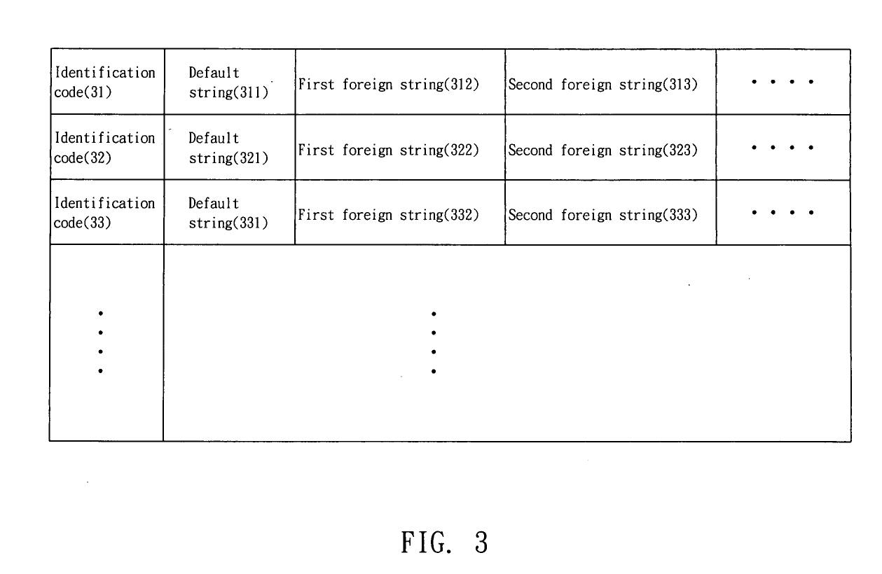

In the present embodiment, as shown in FIG. 3, the string table 3 stores a plurality of default strings 311˜331, and a plurality of foreign strings corresponding to different default strings, such as a first foreign string 312 and a second foreign string 313 corresponding to the default string 311, a first foreign string 322 and a second foreign string 323 corresponding to the default string 321, and a first foreign string 332 and a second foreign string 333 corresponding to the default string 331. For example, if a default string is an English string “Read Error Occur”, the corresponding first foreign string may be a traditional Chinese string [symbol] and the corresponding second foreign string may be a Dutch string “Er komen foutlezingen voor”.

Moreover, each default string has a corresponding identification code. For example, the default string 311 corresponds to the identification code 31, the default string 321 corresponds to the identification code 32, and default string 331 corresponds to the identification code 33.

The method for installing multi-language program according to the preferred embodiment retrieves a foreign string according to the identification code and a language family data. For example, while retrieving the required foreign string according to the identification code 32 and the language data pointing to the second language, the method can retrieve the second foreign string 323 by looking up the string table 3. Using identification codes as the basis of table look-up is a way software developers often use. This way facilitates the software developers to design the string table and write program codes. For example, the identification code “0401” may correspond to the default string of “Read Error Occur” while the first foreign string [symbol] and the second foreign string “Er komen foutlezingen voor” also correspond to the same identification code “0401”. Of course, persons having ordinary skills in the art would understand that it is possible to find the appropriate foreign strings using the default string directly without using identification codes.

In the present embodiment, the string table 3 is a plug-in document, and the language data can be determined according to geographic locations or nations. For example, the language data can be determined by geographic locations such as Asian language data, European language data, American language data and Latin-American language data, or by nations such as US language data, Arabic language data and Dutch language data.

Furthermore, the user interface provided by the above-mentioned steps may further include at least one interface object. A user can link to the original installing object by selecting this interface object. Therefore, from a user's point of view, the procedures of executing an installing program are the same as that of executing the original installing program directly. Moreover, the user interface may be customized to display the foreign string and the interface object in different ways. For example, the operation procedure is not necessarily the same. The user may set the procedure freely, so that the user interface can be presented user-friendlier.

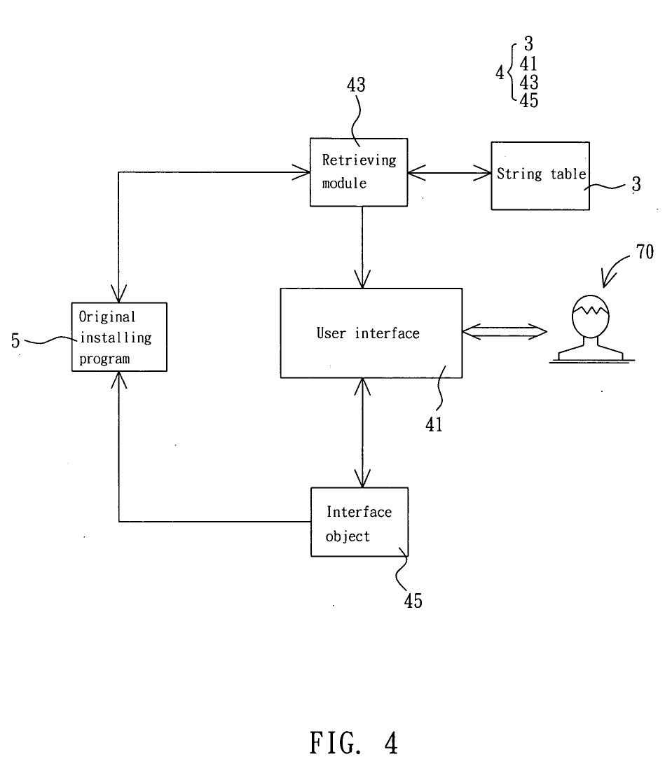

The system for installing multi-language program according to the embodiment of the invention will be described below with reference to FIG. 4.

As shown in FIG. 4, the system for installing multi-language program 4 includes a string table 3 and a user interface 41, and cooperates with an original installing program 5. In the present embodiment, the string table 3 records the default strings of the original installing program 5 and their corresponding foreign strings (as shown in FIG. 3). The user interface 41 displays the foreign string retrieved from the string table 3, such as the first foreign string 312, 322 and 332 or the second foreign string 313, 323 and 333, so that the user 70 can perform necessary operations through the user interface 41. The relevant descriptions of the string table 3 are the same as that mentioned previously, and are omitted here for concise purpose.

As shown in FIG. 4, the system for installing multi-language program 4 further includes a retrieving module 43 and at least one interface object 45. In the present embodiment, the retrieving module 43 retrieves the default string to be displayed according to the original installing program 5, and retrieves the corresponding identification code according to the default string. Then the retrieving module 43 retrieves the corresponding foreign string according to the identification code and the language data. The user interface 41 displays the foreign string retrieved by the retrieving module 43 from the string table.

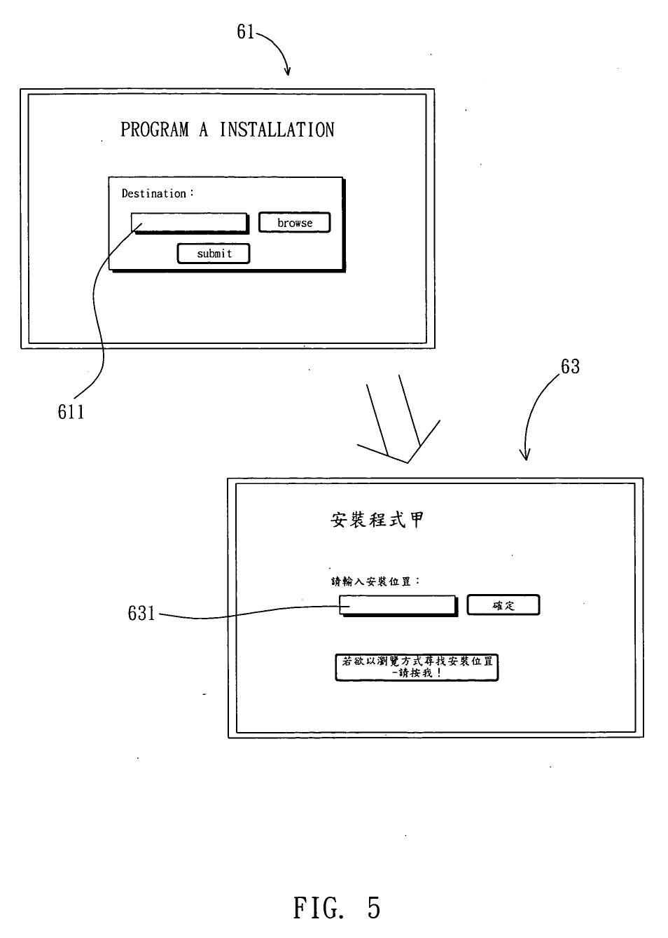

Moreover, the interface object 45 is displayed through the user interface 41, and is linked to the original installing program 5. As shown in FIG. 5, the user interface 41 displays the foreign string and the interface object 45 in a customized way. The window 61 shows the screenshot after executing the original installing program 5 directly, and window 63 is the result of executing the system for installing multi-language program 4. The screenshot of the window 63 is what the user interface 41 displays. In the present embodiment, the default strings of the window 61 include “PROGRAM A INSTALLATION”, “Destination”, “browse”, and “submit”. The language data of the window 63 is “Traditional Chinese”, thus the corresponding foreign strings of the windows 63 are [symbol] [symbol] [symbol] [symbol] [symbol] and [symbol] . Moreover, the window 63 further displays an input field 631, which is equivalent to the input field 611 in window 61, for the user to input necessary data. After the user clicks the “submit” button, the user-input data are input and linked to the original installing program. Here, the input field 631 and the button of [symbol] [symbol] [symbol] can be the previous-mentioned interface objects, which are displayed through the window 63 (the user interface) and are linked to the original installing program.

In summary, since the method and system for installing multi-language program according to the invention utilize the string table of a plug-in to record strings in different languages, the developing costs can be reduced when compared to conventional installing multi-language programs. Furthermore, the string table has a smaller size, thus is easier for transmission. Moreover, since one can modify strings in the string table, it is much convenient for one who wants to change the texts displayed.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for installing multi-language program, comprising:
providing an original installing program having a default string;
generating at least one foreign string corresponding to the default string;
recording the default string and the foreign string correspondingly in a string table; and
providing a user interface to display the foreign string retrieved from the string table.

2. The method according to claim 1, further comprising:
generating an identification code corresponding to the default string; and
recording the identification code correspondingly in the string table.

3. The method according to claim 2, wherein the step of retrieving the foreign string from the string table further comprises:
retrieving the default string to be displayed according to the original installing program;
retrieving the identification code according to the retrieved default string; and
retrieving the foreign string according to the retrieved identification code.

4. The method according to claim 2, wherein the foreign string is retrieved from the string table according to the identification code and a language data.

5. The method according to claim 4, wherein the language data is determined according to geographic locations.

6. The method according to claim 4, wherein the language data is determined according to nations.

7. The method according to claim 1, wherein the string table is a plug-in document.

8. The method according to claim 1, wherein the user interface further comprises an interface object linked to the original installing program.

9. The method according to claim 8, wherein the foreign string and the interface object are displayed on the user interface in a customized way.

10. A system for installing multi-language program cooperating with an original installing program, comprising:
a string table, wherein a default string of the original installing program and a foreign string generated according to the default string are recorded therein; and
a user interface displaying the foreign string retrieved from the string table.

11. The system according to claim 10, wherein the string table further records an identification code corresponding to the default string.

12. The system according to claim 11, further comprising:
a retrieving module retrieving the default string to be displayed and the identification code corresponding to the default string, and retrieving the foreign string corresponding to the identification code, wherein the foreign string retrieved from the string table is displayed on the user interface.

13. The system according to claim 12, wherein the string table records a plurality of foreign strings corresponding to the default string, and the retrieving module retrieves the foreign string from the string table according to the identification code and a language data.

14. The system according to claim 13, wherein the language data is determined according to geographic locations.

15. The system according to claim 13, wherein the language data is determined according to nations.

16. The system according to claim 10, wherein the string table is a plug-in document.

17. The system according to claim 10, further comprising:
at least one interface object displayed by the user interface and linked to the original installing program.

18. The system according to claim 17, wherein the foreign string and the interface object are displayed on the user interface in a customized way.
